(19) United States
(12) Patent Application Publication
(10) Pub. No.: US 2026/0343231 A1
(43) Pub. Date: Oct. 29, 2026

(54) POSITIONING VERIFICATION METHOD AND TERMINAL

(71) Applicant: BEIJING XIAOMI MOBILE SOFTWARE CO., LTD., Beijing (CN)

(72) Inventor: Yajun ZHU, Beijing (CN)

(21) Appl. No.: 19/110,770

(22) PCT Filed: Sep. 22, 2022
(86) PCT No.: PCT/CN2022/120674

§ 371 Date: Mar. 11, 2025

(51) Int. Cl. H04W 12/104; H04W 64/00; H04W 72/0446; H04W 72/0453

(52) U.S. Cl. CPC H04W 12/104; H04W 64/00; H04W 72/0446; H04W 72/0453

(57) ABSTRACT

A positioning verification method is performed by a terminal device in a wireless communications network. The method includes: sending first position information of a terminal device to a network device, the first position information being obtained on the basis of a first positioning measurement; receiving a second positioning measurement configuration sent by the network device; obtaining a second positioning measurement result by performing a second positioning measurement according to the second positioning measurement configuration, the second positioning measurement result being used for determining second position information of the terminal device; and sending first information to the network device, the first information being used for verifying a reliability of the first position information.

### CROSS-REFERENCE TO RELATED APPLICATIONS

This application is a U.S. national phase application of International Application No. PCT/CN2022/120674, filed on Sep. 22, 2022, the content of which is hereby incorporated by reference in its entirety.

### FIELD

The present disclosure relates to the field of wireless communication technologies, and specifically to a positioning verification method and an apparatus.

### BACKGROUND

In scenarios involving non-terrestrial networks (NTN), due to the long signal transmission distance, the data transmission time between a terrestrial terminal device and the NTN is also prolonged. For transmissions involving uplink and downlink relationships, parameters compensating for transmission delay are introduced. Terminal devices need to acquire their own location information to facilitate uplink synchronization compensation.

In the related technologies, terminal devices can obtain their location information based on global navigation satellite system (GNSS) measurements and report it to the network side. However, for the network side, such location information may be falsified or tampered with, making it unreliable.

### SUMMARY

A first aspect of the present disclosure provides a positioning verification method performed by a terminal device. The method includes:
sending first location information of the terminal device to a network device, where the first location information is obtained based on a first positioning measurement;
receiving a second positioning measurement configuration sent by the network device;
performing a second positioning measurement according to the second positioning measurement configuration to obtain a second positioning measurement result, where the second positioning measurement result is used to determine second location information of the terminal device; and
sending first information to the network device, where the first information is used to verify a reliability of the first location information.

A second aspect of the present disclosure provides a positioning verification method performed by a network device. The method includes:
receiving first location information of a terminal device sent by the terminal device, where the first location information is obtained based on a first positioning measurement;
sending a second positioning measurement configuration to the terminal device, where the second positioning measurement configuration is used for the terminal device to perform a second positioning measurement to obtain a second positioning measurement result, and the second positioning measurement result is used to determine second location information of the terminal device;
receiving first information sent by the terminal device; and
verifying a reliability of the first location information based on the first information.

A third aspect of the present disclosure provides a communication apparatus. The apparatus includes a processor and a memory, where the memory stores a computer program, and the processor executes the computer program stored in the memory to enable the apparatus to perform the positioning verification method according to the first aspect of the embodiments.

### BRIEF DESCRIPTION OF THE DRAWINGS

To more clearly illustrate the embodiments of the present disclosure or the technical solutions in the prior art, the following briefly introduces the drawings used in the embodiments.

FIG. 1a is a schematic diagram of a communication system architecture according to an embodiment of the present disclosure;

FIG. 1b is a schematic diagram of uplink and downlink timing-aligned transmission on the network device side;

FIG. 1c is a schematic diagram of uplink and downlink timing-misaligned transmission on the network device side;

FIG. 2 is a flowchart of a positioning verification method performed by a terminal device according to an embodiment of the present disclosure;

FIG. 3 is a flowchart of a positioning verification method according to an embodiment of the present disclosure;

FIG. 4 is a flowchart of a positioning verification method according to an embodiment of the present disclosure;

FIG. 5 is a flowchart of a positioning verification method performed by a network device according to an embodiment of the present disclosure;

FIG. 6 is a flowchart of a positioning verification method according to an embodiment of the present disclosure;

FIG. 7 is a flowchart of a positioning verification method according to an embodiment of the present disclosure;

FIG. 8 is a structural diagram of a positioning verification apparatus according to an embodiment of the present disclosure;

FIG. 9 is a structural diagram of a positioning verification apparatus according to an embodiment of the present disclosure;

FIG. 10 is a structural diagram of another positioning verification apparatus according to an embodiment of the present disclosure; and

FIG. 11 is a structural diagram of a chip according to an embodiment of the present disclosure.

### DETAILED DESCRIPTION

Here, exemplary embodiments will be described in detail, with examples illustrated in the drawings. When the following description refers to the drawings, unless otherwise indicated, the same numbers in different drawings represent the same or similar elements. The implementations described in the following exemplary embodiments do not represent all implementations consistent with the embodiments of the present disclosure. On the contrary, they are merely examples of devices and methods consistent with some aspects of the embodiments of the present disclosure as detailed in the appended claims.

The terms used in the embodiments of the present disclosure are for the purpose of describing specific embodiments only and are not intended to limit the embodiments of the present disclosure. As used in the embodiments of the present disclosure and the appended claims, the singular forms “a,” “an,” and “the” are intended to include the plural forms as well, unless the context clearly indicates otherwise. It should also be understood that the term “and/or” as used herein refers to and includes any or all possible combinations of one or more of the associated listed items.

It should be understood that although the terms “first,” “second,” “third,” etc. may be used in the embodiments of the present disclosure to describe various information, such information should not be limited by these terms. These terms are only used to distinguish one type of information from another. For example, without departing from the scope of the embodiments of the present disclosure, first information may also be referred to as second information, and similarly, second information may also be referred to as first information. Depending on the context, the word “if” or “when” as used herein may be interpreted as “at the time of” or “when” or “in response to determining.”

According to the positioning verification method and apparatus provided by the embodiments of the present disclosure, by sending the first location information of the terminal device to the network device, where the first location information is obtained based on a first positioning measurement, receiving the second positioning measurement configuration sent by the network device, performing the second positioning measurement according to the second positioning measurement configuration to obtain the second positioning measurement result, where the second positioning measurement result is used to determine the second location information of the terminal device, and sending the first information to the network device, where the first information is used to verify a reliability of the first location information, the terminal device can complete network positioning through multiple satellites, thereby allowing the network device to effectively determine whether the location information reported by the terminal is reliable, avoiding the effect on transmissions of other terminals in the NTN system when the location information reported by the terminal is unreliable.

The following describes the embodiments of the present disclosure in detail, with examples of the embodiments illustrated in the accompanying drawings, where the same or similar reference numerals throughout the drawings denote the same or similar elements. The embodiments described below with reference to the accompanying drawings are exemplary and are intended to explain the present disclosure, and should not be construed as limiting the present disclosure.

To better understand the positioning verification method disclosed in the embodiments of the present disclosure, the communication system applicable to the embodiments of the present disclosure is first described below.

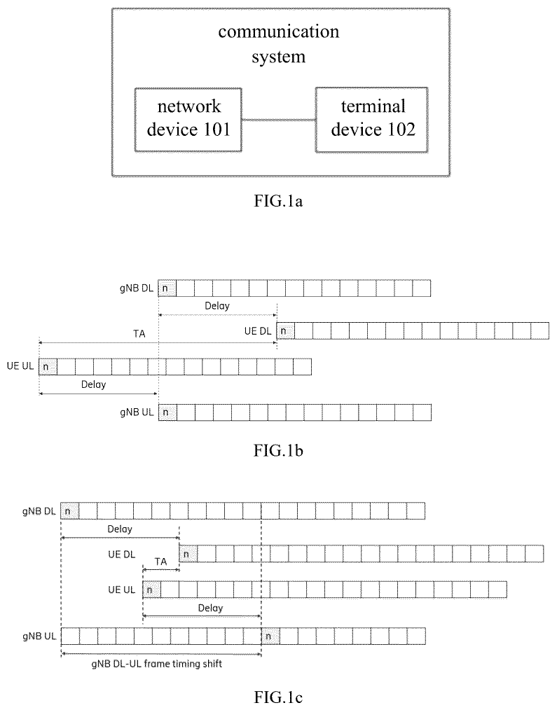

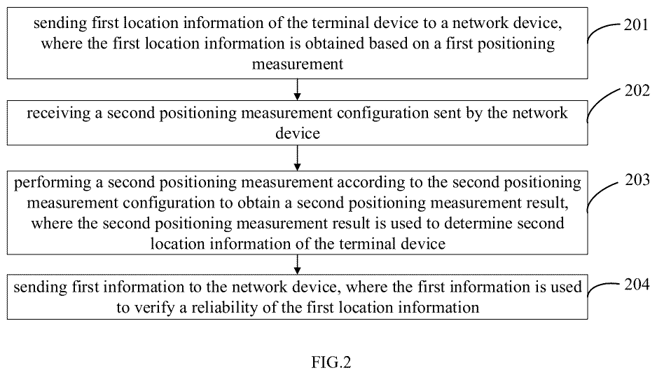

Please refer to FIG. 1a, which is a schematic diagram of a communication system architecture according to an embodiment of the present disclosure. The communication system may include, but is not limited to, one network device and one terminal device. The number and form of devices shown in FIG. 1a are for illustration only and do not limit the embodiments of the present disclosure. In practical disclosures, there may be two or more network devices and two or more terminal devices. The communication system shown in FIG. 1a includes one network device 101 and one terminal device 102 as an example.

It should be noted that the technical solutions of the embodiments of the present disclosure may be applied to various communication systems. For example: Long Term Evolution (LTE) systems, fifth-generation mobile communication systems, 5G new radio (NR) systems, or other future new mobile communication systems.

The network device 101 in the embodiments of the present disclosure is an entity on the network side for transmitting or receiving signals. For example, the network device 101 may be an evolved NodeB (eNB), a transmission reception point (TRP), a next-generation NodeB (gNB) in an NR system, a base station in other future mobile communication systems, or an access node in a Wireless Fidelity (Wi-Fi™) system. The embodiments of the present disclosure do not limit the specific technology and device form used by the network device. The network device provided by the embodiments of the present disclosure may be composed of a central unit (CU) and a distributed unit (DU), where the CU may also be referred to as a control unit (Control Unit). The CU-DU structure can split the protocol layers of the network device, such as a base station, with some protocol layer functions centrally controlled by the CU, and the remaining or all protocol layer functions distributed in the DU, centrally controlled by the CU.

The terminal device 102 in the embodiments of the present disclosure is an entity on the user side for receiving or transmitting signals, such as a mobile phone. The terminal device may also be referred to as a terminal, user equipment (UE), mobile station (MS), mobile terminal (MT), etc. The terminal device may be a car with communication capabilities, a smart car, a mobile phone, an Internet of Things (IOT) terminal, a wearable device, a tablet computer (Pad), a computer with wireless transceiver capabilities, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The embodiments of the present disclosure do not limit the specific technology and device form used by the terminal device.

With the continuous development of wireless communication technologies, satellite communication is considered an important aspect of future wireless communication technology development. In NTN scenarios (such as satellite communication), due to the long signal transmission distance between the sender and receiver, data transmission has a large delay. For transmissions involving uplink and downlink relationships, the current standardization discussions have determined the introduction of a parameter, Koffset, to compensate for the transmission delay. As shown in FIG. 1b and FIG. 1c, FIG. 1b is a schematic diagram of uplink and downlink timing-aligned transmission on the network device side, and FIG. 1c is a schematic diagram of uplink and downlink timing-misaligned transmission on the network device side.

The terminal device can compensate for the transmission delay through ephemeris information and common timing advance (common TA) related information. The ephemeris information and common TA information are notified to the terminal device through system information. The terminal device needs to acquire its own location information to facilitate uplink synchronization compensation.

In related technologies, the terminal device can obtain its location information based on GNSS measurements and report it to the network device. However, for the network side, such location information may be falsified or tampered with, making it unreliable.

In some deployment scenarios, the terminal device 102 can observe multiple satellites, so it is possible to obtain location information through multiple satellites. The location information determined by the network device can be used to verify whether the location information reported by the terminal device based on GNSS measurements is reliable.

It should be understood that the communication system described in the embodiments of the present disclosure is to more clearly illustrate the technical solutions of the embodiments of the present disclosure and does not constitute a limitation on the technical solutions provided by the embodiments of the present disclosure. Those skilled in the art can understand that with the evolution of system architecture and the emergence of new service scenarios, the technical solutions provided by the embodiments of the present disclosure are equally applicable to similar technical problems.

The positioning verification method and apparatus provided by the present disclosure are described in detail below with reference to the drawings.

Please refer to FIG. 2, which is a flowchart of a positioning verification method according to an embodiment of the present disclosure. It should be noted that the positioning verification method in this embodiment is performed by a terminal device. The method can be performed independently or in combination with any other embodiment of the present disclosure. As shown in FIG. 2, the method may include the following steps.

Step 201: sending first location information of the terminal device to a network device, where the first location information is obtained based on a first positioning measurement.

In this embodiment, the terminal device can obtain its own location information based on the first positioning measurement, where the location information is the first location information, and the terminal device can send the first location information to the network device.

Optionally, in the embodiments of the present disclosure, the first positioning measurement may be a global navigation satellite system (GNSS) measurement. The terminal device can perform GNSS measurements and obtain the first location information.

In this embodiment, the terminal device sends the location result based on GNSS measurements to the network device, the terminal device may send the location result periodically, or send the location result after being triggered by the network device.

In some embodiments, the terminal device can receive first configuration information sent by the network device, and periodically send the first location information obtained based on the first positioning measurement to the network device according to the configuration of the first configuration information. The first configuration information is used for the terminal device to send the first location information.

Optionally, the first configuration information may include periodic information for determining when to send the first location information, and related configurations for the terminal device to send the first location information, such as the time-frequency domain location for sending the first location information, the signaling or information including the first location information, etc.

That is, the first configuration information may directly include the above information (periodic information, time-frequency domain location, etc.), or it may carry messages that can determine the above information.

Optionally, the first configuration information may be carried in a higher-layer signaling or a physical-layer signaling sent by the network device.

In some embodiments, the terminal device can receive first indication information sent by the network device, where the first indication information is used to indicate whether the terminal device sends the first location information, and/or to indicate the configuration for sending the first location information.

The configuration for sending the first location information is the configuration for the terminal device to send the first location information, such as the time-frequency domain location for sending the first location information, the signaling or information including the first location information, etc.

That is, as one possible implementation, the first indication information is used to indicate whether the terminal device sends the first location information, and the terminal device may determine whether to send the first location information to the network device based on the indication of the first indication information sent by the network device.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and the configuration for sending the first location information.

Step 202: receiving a second positioning measurement configuration sent by the network device.

In this embodiment, the terminal device can receive the second positioning measurement configuration sent by the network device and perform the second positioning measurement according to the second positioning measurement configuration.

Optionally, in the embodiments of the present disclosure, the second positioning measurement may be a multi-satellite-assisted positioning measurement.

In this embodiment, the second positioning measurement configuration includes at least one of the following information:
an identifier of a satellite assisting positioning;
pilot information for performing the second positioning measurement;
a time-frequency domain location for performing the second positioning measurement; or
periodic information for performing the second positioning measurement.

It should be understood that the satellite assisting positioning refers to at least one satellite participating in the second positioning measurement, and the terminal device can perform the second positioning measurement through the at least one satellite to complete network positioning.

In this embodiment, the second positioning measurement configuration information may be determined by the network device based on information obtained by itself, or it may be determined by the network device based on measurements from the terminal device.

In some embodiments, the second positioning measurement configuration is determined by the network device based on ephemeris information of at least one candidate satellite for assisting positioning.

Optionally, the serving network devices of the terminal device that needs to perform the second positioning measurement can interact with each other through interfaces among network devices or other means to obtain ephemeris-related information of at least one candidate satellite for assisting positioning. Based on the ephemeris-related information, the network device can determine at least one satellite assisting positioning from the at least one candidate satellite for assisting positioning.

In some embodiments, the second positioning measurement configuration is determined by the network device based on a third measurement result sent by the terminal device.

The third measurement result is obtained through measuring, by the terminal device, at least one candidate satellite for assisting positioning based on third configuration information sent by the network device. The third configuration information is sent by the network device to the terminal device for measuring the at least one candidate satellite for assisting positioning.

It should be understood that the at least one candidate satellite for assisting positioning refers to at least one satellite that the terminal device can observe and that can be used to assist in positioning. The network device can determine the at least one satellite assisting positioning from the at least one candidate satellite for assisting positioning based on information obtained by itself or the third measurement result sent by the terminal device.

Further, in some embodiments, the terminal device can further receive fourth configuration information, where the fourth configuration information is used for the terminal device to send the third measurement result. According to the fourth configuration information, the terminal device can send the third measurement result at the time-frequency domain location configured by the fourth configuration information.

Optionally, the third configuration information includes at least one of the following:
an identifier of the at least one candidate satellite for assisting positioning;
a time-frequency domain location for measuring the at least one candidate satellite for assisting positioning; or
pilot information of the at least one candidate satellite for assisting positioning.

The terminal device can detect the pilot of the candidate satellite at the configured time-frequency domain location according to the third configuration information to determine the measurement result of the candidate satellite.

Optionally, the third measurement result includes at least one of the following: ephemeris information of the at least one candidate satellite for assisting positioning; and/or received signal strength information corresponding to each candidate satellite in the at least one candidate satellite for assisting positioning.

It should be understood that the third configuration information can be flexibly configured and adjusted according to actual needs. The third measurement result can also include other information that the terminal device can measure according to actual needs, so that the network device can determine the second measurement configuration information based on the third measurement result.

Step 203: performing a second positioning measurement according to the second positioning measurement configuration to obtain a second positioning measurement result, where the second positioning measurement result is used to determine second location information of the terminal device.

In this embodiment, the terminal device can perform the second positioning measurement according to the received second positioning measurement configuration to obtain the second positioning measurement result. The second positioning measurement result is used to determine the second location information of the terminal device.

Optionally, the second positioning measurement result may include a time difference of arrival (TDOA), and/or multiple round-trip times (Multi-RTT), etc.

Optionally, in this embodiment, the terminal device may determine its own second location information based on the second positioning measurement result, or the network device may determine the second location information of the terminal device based on the second measurement result.

It should be understood that the second positioning measurement result may also include other information used for positioning according to actual needs, so as to determine the second location information of the terminal device.

Step 204: sending first information to the network device, where the first information is used to verify a reliability of the first location information.

In this embodiment, the terminal device can send the first information to the network device, where the first information is used to verify whether the first location information obtained based on the first positioning measurement and reported to the network device is reliable.

Optionally, the first information may be the second positioning measurement result obtained by performing the second positioning measurement, or it may be the second location information obtained based on the second measurement result.

In some embodiments, the terminal device sends the second measurement result to the network device, and the network device verifies the reliability of the first location information based on the second measurement result.

In some embodiments, the terminal device determines the second location information based on the second measurement result and sends the second location information to the network device, and the network device verifies the reliability of the first location information based on the second location information.

In summary, by sending the first location information of the terminal device to the network device, where the first location information is obtained based on the first positioning measurement, receiving the second positioning measurement configuration sent by the network device, performing the second positioning measurement according to the second positioning measurement configuration to obtain the second positioning measurement result, where the second positioning measurement result is used to determine the second location information of the terminal device, and sending the first information to the network device, where the first information is used to verify a reliability of the first location information, the terminal device can complete a network positioning through multiple satellites, thereby enabling the network device to effectively determine whether the location information reported by the terminal is reliable, avoiding the effect on transmissions of other terminals in the NTN system when the location information reported by the terminal is unreliable.

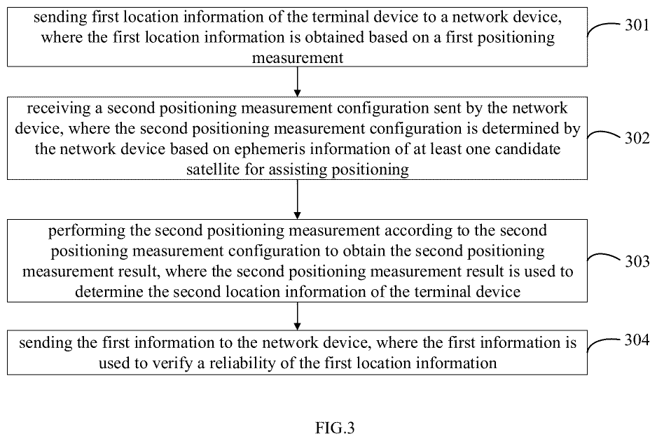

Please refer to FIG. 3 which is a flowchart of a positioning verification method according to an embodiment of the present disclosure. It should be noted that the positioning verification method in this embodiment is performed by a terminal device. The method can be performed independently or in combination with any other embodiment of the present disclosure. As shown in FIG. 3, the method may include the following steps.

Step 301: sending first location information of the terminal device to a network device, where the first location information is obtained based on a first positioning measurement.

In this embodiment, the terminal device can obtain its own location information based on the first positioning measurement, where the location information is the first location information, and terminal device can send the first location information to the network device.

Optionally, in the embodiments of the present disclosure, the first positioning measurement may be a GNSS measurement. The terminal device can perform GNSS measurements and obtain the first location information.

In this embodiment, the terminal device sends to the network device the location result based on GNSS measurements, the terminal device may send the location result periodically, or send the location result after being triggered by the network device.

In some embodiments, the terminal device can receive first configuration information sent by the network device, and periodically send the first location information obtained based on the first positioning measurement to the network device according to the configuration of the first configuration information. The first configuration information is used for the terminal device to send the first location information.

Optionally, the first configuration information may include periodic information for determining when to send the first location information, and related configurations for the terminal device to send the first location information, such as the time-frequency domain location for sending the first location information, the signaling or information including the first location information, etc.

Optionally, the first configuration information may be carried in higher-layer signaling or physical-layer signaling sent by the network device.

In some embodiments, the terminal device can receive first indication information sent by the network device, where the first indication information is used to indicate whether the terminal device sends the first location information, and/or to indicate the configuration for sending the first location information.

The configuration for sending the first location information is the configuration for the terminal device to send the first location information, such as the time-frequency domain location for sending the first location information, the signaling or information including the first location information, etc.

That is, as one possible implementation, the first indication information is used to indicate whether the terminal device sends the first location information, and the terminal device can determine whether to send the first location information to the network device based on the indication of the first indication information sent by the network device.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and the configuration for sending the first location information.

Step 302: receiving a second positioning measurement configuration sent by the network device, where the second positioning measurement configuration is determined by the network device based on ephemeris information of at least one candidate satellite for assisting positioning.

In this embodiment, the terminal device can receive the second positioning measurement configuration sent by the network device and perform the second positioning measurement according to the second positioning measurement configuration. The second positioning measurement configuration is determined by the network device based on ephemeris information of at least one candidate satellite for assisting positioning.

Optionally, in the embodiments of the present disclosure, the second positioning measurement may be a multi-satellite-assisted positioning measurement.

Optionally, the serving network devices of the terminal device that needs to perform the second positioning measurement can interact with each other through interfaces among network devices or other means to obtain ephemeris-related information of at least one candidate satellite for assisting positioning. Based on the ephemeris-related information, the network device can determine at least one satellite assisting positioning from the at least one candidate satellite for assisting positioning.

In this embodiment, the second positioning measurement configuration includes at least one of the following information:
an identifier of a satellite assisting positioning;
pilot information for performing the second positioning measurement;
a time-frequency domain location for performing the second positioning measurement; or
periodic information for performing the second positioning measurement.

It should be understood that the satellite assisting positioning refers to at least one satellite participating in the second positioning measurement, and the terminal device can perform the second positioning measurement through the at least one satellite to complete network positioning. The at least one candidate satellite for assisting positioning refers to at least one satellite that the terminal device can observe and that can be used to assist in positioning.

Step 303: performing the second positioning measurement according to the second positioning measurement configuration to obtain the second positioning measurement result, where the second positioning measurement result is used to determine the second location information of the terminal device.

In this embodiment, the terminal device can perform the second positioning measurement according to the second positioning measurement configuration to obtain the second positioning measurement result. The second positioning measurement result is used to determine the second location information of the terminal device.

For example, the terminal device can perform the second positioning measurement according to the second positioning measurement configuration, detect periodically the configured pilot information at the configured time-frequency domain location according to the configured periodic information, etc.

Optionally, the second positioning measurement result may include a time difference of arrival (TDOA), and/or multiple round-trip times (Multi-RTT), etc. The terminal device or the network device can determine the location information of the terminal device based on the second positioning measurement result, where the location information is referred to as the second location information.

Optionally, in this embodiment, the terminal device may determine its own second location information based on the second positioning measurement result, or the network device may determine the second location information of the terminal device based on the second measurement result.

It should be understood that the second positioning measurement result may also include other information used for positioning according to actual needs, so as to determine the second location information of the terminal device.

Step 304: sending the first information to the network device, where the first information is used to verify a reliability of the first location information.

In this embodiment, the terminal device can send the first information to the network device, where the first information is used to verify whether the first location information obtained based on the first positioning measurement and reported to the network device is reliable.

Optionally, the first information may be the second positioning measurement result obtained by performing the second positioning measurement, or it may be the second location information obtained based on the second measurement result.

In some embodiments, the terminal device sends the second measurement result to the network device, and the network device verifies the reliability of the first location information based on the second measurement result.

In some embodiments, the terminal device determines the second location information based on the second measurement result and sends the second location information to the network device, and the network device verifies the reliability of the first location information based on the second location information.

In summary, by sending the first location information of the terminal device to the network device, where the first location information is obtained based on the first positioning measurement, receiving the second positioning measurement configuration sent by the network device, where the second positioning measurement configuration is determined by the network device based on ephemeris information of at least one candidate satellite for assisting positioning, performing the second positioning measurement according to the second positioning measurement configuration to obtain the second positioning measurement result, where the second positioning measurement result is used to determine the second location information of the terminal device, and sending the first information to the network device, where the first information is used to verify the reliability of the first location information, the terminal device can complete network positioning through multiple satellites, thereby enabling the network device to effectively determine whether the location information reported by the terminal is reliable, avoiding the effect on transmissions of other terminals in the NTN system when the reported location information is unreliable.

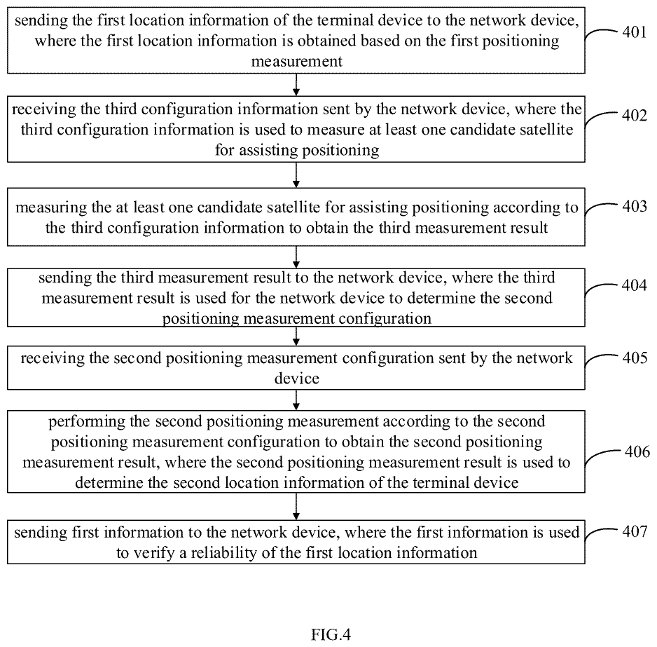

Please refer to FIG. 4, which is a flowchart of a positioning verification method according to an embodiment of the present disclosure. It should be noted that the positioning verification method in this embodiment is performed by a terminal device. The method can be performed independently or in combination with any other embodiment of the present disclosure. As shown in FIG. 4, the method may include the following steps.

Step 401: sending the first location information of the terminal device to the network device, where the first location information is obtained based on the first positioning measurement.

In this embodiment, the terminal device can obtain its own location information based on the first positioning measurement, where the location information is the first location information, and the terminal device can send the first location information to the network device.

Optionally, in the embodiments of the present disclosure, the first positioning measurement may be a GNSS measurement. The terminal device can perform GNSS measurements and obtain the first location information.

In this embodiment, the terminal device sends the location result based on GNSS measurements to the network device, the terminal device may send the location result periodically, or send the location result after being triggered by the network device.

In some embodiments, the terminal device can receive first configuration information sent by the network device and, according to the configuration of the first configuration information, periodically send the first location information obtained based on the first positioning measurement to the network device. The first configuration information is used for the terminal device to send the first location information.

Optionally, the first configuration information may include periodic information for determining when to send the first location information, and related configurations for the terminal device to send the first location information, such as the time-frequency domain location for sending the first location information, the signaling or information including the first location information, etc.

Optionally, the first configuration information may be carried in higher-layer signaling or physical-layer signaling sent by the network device.

In some embodiments, the terminal device can receive first indication information sent by the network device, where the first indication information is used to indicate whether the terminal device sends the first location information, and/or to indicate the configuration for sending the first location information.

The configuration for sending the first location information includes configurations related to the terminal device sending the first location information, such as the time-frequency domain location for sending the first location information, the signaling or information including the first location information, etc.

That is, as one possible implementation, the first indication information is used to indicate whether the terminal device sends the first location information, and the terminal device can determine whether to send the first location information to the network device based on the indication of the first indication information sent by the network device.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and the configuration for sending the first location information.

Step 402: receiving the third configuration information sent by the network device, where the third configuration information is used to measure at least one candidate satellite for assisting positioning.

In this embodiment, the terminal device can receive the third configuration information sent by the network device and measure at least one candidate satellite for assisting positioning according to the third configuration information.

It should be understood that the at least one candidate satellite for assisting positioning refers to at least one satellite that the terminal device can observe and that can be used to assist in positioning.

Optionally, in this embodiment, the third configuration information includes at least one of the following:
an identifier of the at least one candidate satellite for assisting positioning;
a time-frequency domain location for measuring the at least one candidate satellite for assisting positioning; or
pilot information of the at least one candidate satellite for assisting positioning.

It should be understood that the third configuration information can be flexibly configured and adjusted according to actual needs.

Step 403: measuring the at least one candidate satellite for assisting positioning according to the third configuration information to obtain the third measurement result.

In this embodiment, the terminal device can measure the at least one candidate satellite for assisting positioning according to the received third configuration information to obtain the third measurement result. The third measurement result is used for the network device to determine the second positioning measurement configuration.

For example, the terminal device can detect the pilot of the candidate satellite at the configured time-frequency domain location according to the third configuration information to determine the measurement result of the candidate satellite.

Optionally, the third measurement result includes at least one of the following: ephemeris information of the at least one candidate satellite for assisting positioning; and/or received signal strength information corresponding to each candidate satellite in the at least one candidate satellite for assisting positioning.

The received signal strength information may be the average strength of the received signal over a period of time, or other strength indications, etc.

It should be understood that the third measurement result may further include other information that the terminal device can measure according to actual needs, so that the network device can determine the second measurement configuration information based on the third measurement result.

Step 404: sending the third measurement result to the network device, where the third measurement result is used for the network device to determine the second positioning measurement configuration.

In this embodiment, after measuring the at least one candidate satellite for assisting positioning according to the third configuration information to obtain the third measurement result, the terminal device can send the third measurement result to the network device, and the network device can determine the second positioning measurement configuration based on the third measurement result.

Further, in some embodiments, the terminal device can also receive fourth configuration information, where the fourth configuration information is used for the terminal device to send the third measurement result. The terminal device can send, according to the fourth configuration information, the third measurement result at the time-frequency domain location configured by the fourth configuration information.

Step 405: receiving the second positioning measurement configuration sent by the network device.

In this embodiment, the terminal device can receive the second positioning measurement configuration determined by the network device based on the third measurement result and perform the second positioning measurement according to the second positioning measurement configuration.

Optionally, in the embodiments of the present disclosure, the second positioning measurement may be a multi-satellite-assisted positioning measurement.

In this embodiment, the second positioning measurement configuration includes at least one of the following information:
an identifier of a satellite assisting positioning;
pilot information for performing the second positioning measurement;
a time-frequency domain location for performing the second positioning measurement; or
periodic information for performing the second positioning measurement.

It should be understood that the satellite assisting positioning refers to at least one satellite participating in the second positioning measurement, and the terminal device can perform the second positioning measurement through the at least one satellite to complete network positioning.

Step 406: performing the second positioning measurement according to the second positioning measurement configuration to obtain the second positioning measurement result, where the second positioning measurement result is used to determine the second location information of the terminal device.

In the embodiments of the present disclosure, the terminal device can perform a second positioning measurement according to the second positioning measurement configuration to obtain a second positioning measurement result. The second positioning measurement result is used to determine the second location information of the terminal device.

For example, the terminal device can, according to the second positioning measurement configuration, periodically detect the configured pilot information and the like at the configured time-frequency domain location, based on the configured periodic information.

Optionally, the second positioning measurement result may include Time Difference of Arrival (TDOA), and/or Multiple Round-Trip Time (Multi-RTT), etc. The terminal device or the network device can determine the location information of the terminal device based on the second positioning measurement result, and this location information is referred to as the second location information.

Optionally, in the embodiments of the present disclosure, the terminal device may determine its own second location information based on the second positioning measurement result, or the network device may determine the second location information of the terminal device based on the second measurement result.

It can be understood that the second positioning measurement result may also include other information for positioning according to actual requirements, so as to determine the second location information of the terminal device.

Step 407: sending first information to the network device, where the first information is used to verify a reliability of the first location information.

In the embodiments of the present disclosure, the terminal device can send the first information to the network device, where the first information is used to verify whether the first location information obtained based on the first positioning measurement and reported by the terminal device to the network device is reliable.

Optionally, the first information may be the second positioning measurement result obtained by performing the second positioning measurement, or the second location information obtained based on the second measurement result.

In some embodiments, the terminal device sends the second measurement result to the network device, and the network device verifies whether the first location information is reliable based on the second measurement result.

In some embodiments, the terminal device determines the second location information based on the second measurement result and sends the second location information to the network device, and the network device verifies whether the first location information is reliable based on the second location information.

In summary, by sending the first location information of the terminal device to the network device, where the first location information is obtained based on the first positioning measurement, receiving third configuration information sent by the network device, where the third configuration information is used to measure at least one candidate satellite for assisting positioning, measuring the at least one candidate satellite for assisting positioning according to the third configuration information to obtain a third measurement result, sending the third measurement result to the network device, where the third measurement result is used by the network device to determine the second positioning measurement configuration, receiving the second positioning measurement configuration sent by the network device, performing the second positioning measurement according to the second positioning measurement configuration to obtain the second positioning measurement result, where the second positioning measurement result is used to determine the second location information of the terminal device, and sending the first information to the network device, where the first information is used to verify the reliability of the first location information, the terminal device can complete network positioning through multiple satellites, thereby enabling the network device to effectively determine whether the location information reported by the terminal is reliable, and avoiding the effect on the transmission of other terminals in the NTN system when the location reported by the terminal is unreliable.

Please refer to FIG. 5, which is a schematic flowchart of a positioning verification method provided by an embodiment of the present disclosure. It should be noted that the positioning verification method in this embodiment is performed by the network device. This method can be performed independently or in combination with any other embodiment of the present disclosure. As shown in FIG. 5, the method may include the following steps.

Step 501: receiving first location information of a terminal device sent by the terminal device, where the first location information is obtained based on a first positioning measurement.

In the embodiments of the present disclosure, the network device can receive the first location information of the terminal device sent by the terminal device, where the first location information is determined by the terminal device based on the first positioning measurement.

Optionally, in the embodiments of the present disclosure, the first positioning measurement may be a GNSS measurement. The terminal device can perform the GNSS measurement and obtain the first location information.

In this embodiment, the terminal device sends the location result based on GNSS measurements to the network device, the terminal device may send the location result periodically, or send the location result after being triggered by the network device.

In some embodiments, the network device can send first configuration information to the terminal device, where the first configuration information is used for the terminal device to send the first location information. The terminal device can periodically send the first location information obtained based on the first positioning measurement to the network device according to the configuration of the first configuration information.

Optionally, the first configuration information may include periodic information for determining the sending of the first location information, as well as configurations related to the terminal device sending the first location information, such as the time-frequency domain location for sending the first location information, signaling or information including the first location information, and so on.

That is, the first configuration information may directly include the above information (periodic information, time-frequency domain location, etc.), or may carry messages that can determine the above information.

Optionally, the first configuration information may be carried in high-layer signaling or physical-layer signaling sent by the network device.

In some embodiments, the network device can send first indication information to the terminal device, where the first indication information is used to indicate whether the terminal device sends the first location information, and/or to indicate the configuration for sending the first location information.

The configuration for sending the first location information is related to the terminal device sending the first location information, such as the time-frequency domain location for sending the first location information, signaling or information including the first location information, and so on.

That is, as a possible implementation, the first indication information is used to indicate whether the terminal device sends the first location information, and the terminal device can determine whether to send the first location information to the network device according to the indication of the first indication information sent by the network device.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and the configuration for sending the first location information.

Step 502: sending a second positioning measurement configuration to the terminal device, where the second positioning measurement configuration is used for the terminal device to perform the second positioning measurement to obtain the second positioning measurement result, and the second positioning measurement result is used to determine the second location information of the terminal device.

In the embodiments of the present disclosure, the network device can send the second positioning measurement configuration to the terminal device, where the second positioning measurement configuration is used for the terminal device to perform the second positioning measurement to obtain the second positioning measurement result. The second positioning measurement result is used to determine the second location information of the terminal device.

Optionally, in the embodiments of the present disclosure, the second positioning measurement may be a multi-satellite-assisted positioning measurement.

In the embodiments of the present disclosure, the second positioning measurement configuration includes at least one of the following information:
an identifier of a satellite assisting positioning;
pilot information for performing the second positioning measurement;
a time-frequency domain location for performing the second positioning measurement; or
periodic information for performing the second positioning measurement.

It can be understood that the satellite assisting positioning refers to at least one satellite participating in the second positioning measurement, and the terminal device can perform the second positioning measurement through the at least one satellite to complete network positioning.

In the embodiments of the present disclosure, the second positioning measurement configuration information may be determined by the network device based on information obtained by itself, or it may be determined by the network device based on measurements from the terminal device.

In some embodiments, the network device obtains ephemeris information of at least one candidate satellite for assisting positioning and determines the second positioning measurement configuration based on the obtained ephemeris information.

Optionally, the serving network devices of the terminal device that needs to perform the second positioning measurement can interact with each other through interfaces among network devices or other means to obtain ephemeris-related information of at least one candidate satellite for assisting positioning. Based on the ephemeris-related information, the network device can determine at least one satellite assisting positioning from the at least one candidate satellite for assisting positioning.

In some embodiments, the network device receives a third measurement result sent by the terminal device and determines the second positioning measurement configuration based on the third measurement result.

The third measurement result is obtained by the terminal device measuring at least one candidate satellite for assisting positioning based on third configuration information sent by the network device. The third configuration information is sent by the network device to the terminal device for measuring at least one candidate satellite for assisting positioning.

It can be understood that the at least one candidate satellite for assisting positioning refers to at least one satellite that can be observed by the terminal device and can be used for assisting positioning. The network device can determine the at least one satellite for assisting positioning from the at least one candidate satellite for assisting positioning based on information obtained by itself or the third measurement result sent by the terminal device.

Further, in some embodiments, the network device can also send fourth configuration information to the terminal device, where the fourth configuration information is used for the terminal device to send the third measurement result. The terminal device can send, according to the fourth configuration information, the third measurement result at the time-frequency domain location configured by the fourth configuration information.

Optionally, the third configuration information includes at least one of the following:
an identifier of the at least one candidate satellite for assisting positioning;
a time-frequency domain location for measuring the at least one candidate satellite for assisting positioning; or
pilot information of the at least one candidate satellite for assisting positioning.

The terminal device can detect the pilot of the candidate satellite at the configured time-frequency domain location according to the third configuration information to determine the measurement result of the candidate satellite.

Optionally, the third measurement result includes at least one of the following: ephemeris information of the at least one candidate satellite for assisting positioning; received signal strength information corresponding to each candidate satellite of the at least one candidate satellite for assisting positioning.

It can be understood that the third configuration information can be flexibly configured and adjusted according to actual requirements. The third measurement result can also include other information that can be measured by the terminal device according to actual requirements, so that the network device can determine the second measurement configuration information based on the third measurement result.

Step 503: receiving the first information sent by the terminal device.

In the embodiments of the present disclosure, the network device can receive the first information sent by the terminal device, where the first information is used to verify whether the first location information obtained based on the first positioning measurement and reported by the terminal device to the network device is reliable.

Optionally, the first information may be the second positioning measurement result obtained by performing the second positioning measurement, or the second location information obtained based on the second measurement result.

The second measurement result is obtained through performing, by the terminal device, the second positioning measurement according to the received second positioning measurement configuration. The second positioning measurement result is used to determine the second location information of the terminal device.

Optionally, the second positioning measurement result may include Time Difference of Arrival (TDOA), and/or Multiple Round-Trip Time (Multi-RTT), etc.

It can be understood that the second positioning measurement result may also include other information for positioning according to actual requirements, so as to determine the second location information of the terminal device.

Optionally, in the embodiments of the present disclosure, the terminal device may determine its own second location information based on the second positioning measurement result, or the network device may determine the second location information of the terminal device based on the second measurement result.

Step 504: verifying a reliability of the first location information based on the first information.

In the embodiments of the present disclosure, the network device can verify the reliability of the first location information reported by the terminal device based on the first information sent by the terminal device.

As described hereinabove, the first information may be the second positioning measurement result obtained by performing the second positioning measurement, or the second location information obtained based on the second measurement result.

In some embodiments, the network device receives the second measurement result sent by the terminal device, and the network device verifies whether the first location information is reliable based on the second measurement result.

In some embodiments, the network device receives the second location information determined by the terminal device based on the second measurement result, and the network device verifies whether the first location information is reliable based on the second location information.

In summary, by receiving the first location information of the terminal device sent by the terminal device, where the first location information is obtained based on the first positioning measurement, sending the second positioning measurement configuration to the terminal device, where the second positioning measurement configuration is used for the terminal device to perform the second positioning measurement to obtain the second positioning measurement result, and the second positioning measurement result is used to determine the second location information of the terminal device, receiving the first information sent by the terminal device, and verifying the reliability of the first location information based on the first information, the terminal device can complete network positioning through multiple satellites, thereby enabling the network device to effectively determine whether the location information reported by the terminal is reliable, and avoiding the effect on the transmission of other terminals in the NTN system when the location reported by the terminal is unreliable.

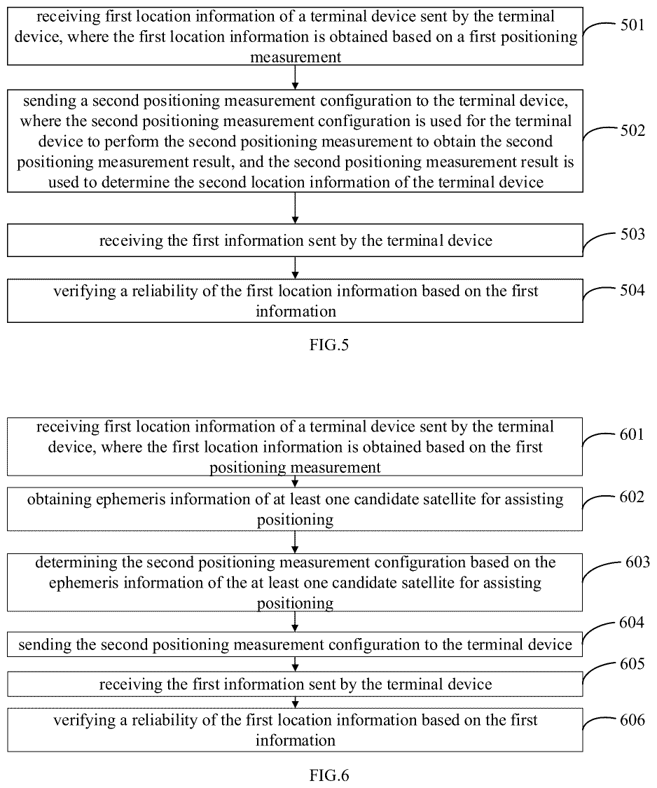

Please refer to FIG. 6, which is a schematic flowchart of a positioning verification method provided by an embodiment of the present disclosure. It should be noted that the positioning verification method in this embodiment is performed by the network device. This method can be performed independently or in combination with any other embodiment of the present disclosure. As shown in FIG. 6, the method may include the following steps.

Step 601: receiving first location information of a terminal device sent by the terminal device, where the first location information is obtained based on the first positioning measurement.

In the embodiments of the present disclosure, the network device can receive the first location information of the terminal device sent by the terminal device, where the first location information is determined by the terminal device based on the first positioning measurement.

Optionally, in the embodiments of the present disclosure, the first positioning measurement may be a GNSS measurement. The terminal device can perform the GNSS measurement and obtain the first location information.

In the embodiments of the present disclosure, the terminal device sends to the network device the location result based on GNSS measurements, the terminal device may send the location result periodically, or send the location result after being triggered by the network device.

In some embodiments, the network device can send first configuration information to the terminal device, where the first configuration information is used for the terminal device to send the first location information. The terminal device can periodically send the first location information obtained based on the first positioning measurement to the network device according to the configuration of the first configuration information.

Optionally, the first configuration information may include periodic information for determining the sending of the first location information, as well as configurations related to the terminal device sending the first location information, such as the time-frequency domain location for sending the first location information, signaling or information including the first location information, and so on.

Optionally, the first configuration information may be carried in high-layer signaling or physical-layer signaling sent by the network device.

In some embodiments, the network device can send first indication information to the terminal device, where the first indication information is used to indicate whether the terminal device sends the first location information, and/or to indicate the configuration for sending the first location information.

The configuration for sending the first location information is related to the terminal device sending the first location information, such as the time-frequency domain location for sending the first location information, signaling or information including the first location information, and so on.

That is, as a possible implementation, the first indication information is used to indicate whether the terminal device sends the first location information, and the terminal device can determine whether to send the first location information to the network device according to the indication of the first indication information sent by the network device.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and indicate the configuration for sending the first location information.

Step 602: obtaining ephemeris information of at least one candidate satellite for assisting positioning.

In the embodiments of the present disclosure, the network device can obtain ephemeris information of at least one candidate satellite for assisting positioning and determine the second positioning measurement configuration based on the ephemeris information.

Optionally, the serving network devices of the terminal device that needs to perform the second positioning measurement can interact with each other through interfaces among network devices or other means to obtain ephemeris-related information of at least one candidate satellite for assisting positioning. Based on the ephemeris-related information, the network device can determine at least one satellite for assisting positioning from the at least one candidate satellite for assisting positioning.

It can be understood that the at least one candidate satellite for assisting positioning refers to at least one satellite that can be observed by the terminal device and can be used for assisting positioning.

Step 603: determining the second positioning measurement configuration based on the ephemeris information of the at least one candidate satellite for assisting positioning.

The second positioning measurement configuration is used for the terminal device to perform the second positioning measurement to obtain the second positioning measurement result, and the second positioning measurement result is used to determine the second location information of the terminal device.

In the embodiments of the present disclosure, based on the obtained ephemeris-related information, the network device can determine at least one satellite for assisting positioning from the at least one candidate satellite for assisting positioning.

In the embodiments of the present disclosure, the second positioning measurement configuration includes at least one of the following information:
an identifier of a satellite assisting positioning;
pilot information for performing the second positioning measurement;
a time-frequency domain location for performing the second positioning measurement; or
periodic information for performing the second positioning measurement.

It can be understood that the satellite assisting positioning refers to at least one satellite participating in the second positioning measurement, and the terminal device can perform the second positioning measurement through the at least one satellite to complete network positioning.

Step 604: sending the second positioning measurement configuration to the terminal device.

In the embodiments of the present disclosure, the network device can send the second positioning measurement configuration to the terminal device, where the second positioning measurement configuration is used for the terminal device to perform the second positioning measurement to obtain the second positioning measurement result. The second positioning measurement result is used to determine the second location information of the terminal device.

Optionally, in the embodiments of the present disclosure, the second positioning measurement may be a multi-satellite-assisted positioning measurement.

Step 605: receiving the first information sent by the terminal device.

In the embodiments of the present disclosure, the network device can receive the first information sent by the terminal device, where the first information is used to verify whether the first location information obtained based on the first positioning measurement and reported by the terminal device to the network device is reliable.

Optionally, the first information may be the second positioning measurement result obtained by performing the second positioning measurement, or may be the second location information obtained based on the second measurement result.

The second measurement result is obtained through performing, by the terminal device, second positioning measurement according to the received second positioning measurement configuration. The second positioning measurement result is used to determine the second location information of the terminal device.

Optionally, the second positioning measurement result may include Time Difference of Arrival (TDOA), and/or Multiple Round-Trip Time (Multi-RTT), etc.

It can be understood that the second positioning measurement result may also include other information required for positioning based on actual needs, to facilitate the determination of the second location information of the terminal device.

Optionally, in the embodiments of the present disclosure, the terminal device may determine its own second location information based on the second positioning measurement result, or the network device may determine the second location information of the terminal device based on the second measurement result.

Step 606: verifying a reliability of the first location information based on the first information.

In the embodiments of the present disclosure, the network device can verify the reliability of the first location information reported by the terminal device based on the first information sent by the terminal device.

As described above, the first information may be the second positioning measurement result obtained by performing the second positioning measurement, or may be the second location information determined based on the second measurement result.

In some embodiments, the network device receives the second measurement result sent by the terminal device and verifies whether the first location information is reliable based on the second measurement result.

In some embodiments, the network device receives the second location information determined by the terminal device based on the second measurement result and verifies the reliability of the first location information based on the second location information.

In summary, by receiving the first location information of the terminal device sent by the terminal device, where the first location information is obtained based on the first positioning measurement, obtaining ephemeris information of at least one candidate satellite for assisting positioning, determining the second positioning measurement configuration based on the ephemeris information of the at least one candidate satellite for assisting positioning, sending the second positioning measurement configuration to the terminal device, receiving the first information sent by the terminal device, and verifying the reliability of the first location information based on the first information, the terminal device can complete network positioning through multiple satellites. This enables the network device to effectively determine whether the location information reported by the terminal is reliable, avoiding the effect on transmissions of other terminals in an NTN system when the reported location is unreliable.

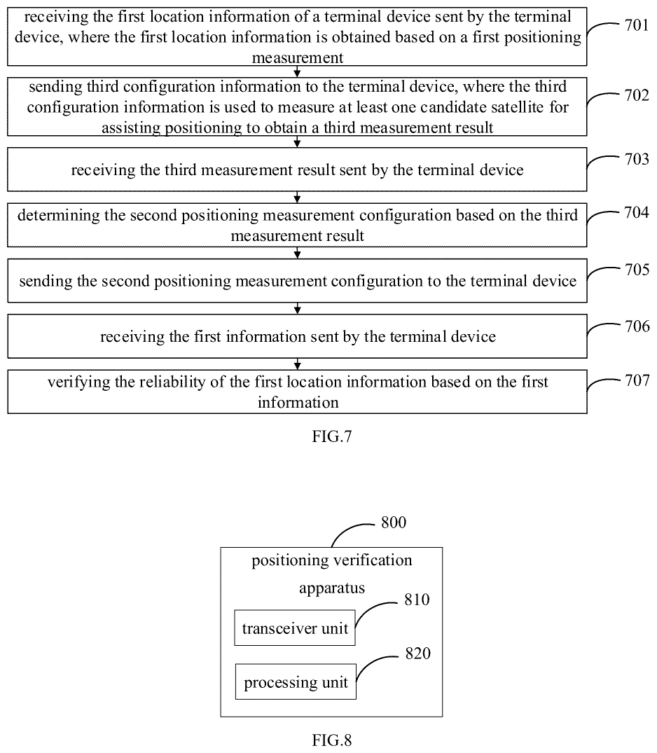

Please refer to FIG. 7, which is a schematic flowchart of a positioning verification method according to an embodiment of the present disclosure. It should be noted that the positioning verification method in this embodiment is performed by the network device. The method may be performed independently or in combination with any other embodiment of the present disclosure. As shown in FIG. 7, the method includes the following steps.

Step 701: receiving the first location information of a terminal device sent by the terminal device, where the first location information is obtained based on a first positioning measurement.

In the embodiments of the present disclosure, the network device can receive the first location information of the terminal device sent by the terminal device, where the first location information is determined by the terminal device based on the first positioning measurement.

Optionally, in the embodiments of the present disclosure, the first positioning measurement may be a GNSS measurement. The terminal device can perform GNSS measurement and obtain the first location information.

In the embodiments of the present disclosure, the terminal device sends the location result based on GNSS measurements to the network device, the terminal device may send the location result periodically, or send the location result after being triggered by the network device.

In some embodiments, the network device may send first configuration information to the terminal device, where the first configuration information is used for the terminal device to send the first location information. The terminal device can periodically send the first location information obtained based on the first positioning measurement to the network device according to the configuration of the first configuration information.

Optionally, the first configuration information may include periodic information for sending the first location information and related configurations such as the time-frequency domain location for sending the first location information, signaling or information containing the first location information, etc.

Optionally, the first configuration information may be carried in higher layer signaling or physical layer signaling sent by the network device.

In some embodiments, the network device may send first indication information to the terminal device, where the first indication information is used to indicate whether the terminal device sends the first location information and/or to indicate a configuration for sending the first location information.

The configuration for sending the first location information includes configurations related to sending the first location information, such as the time-frequency domain location for sending the first location information or the signaling/information containing the first location information.

As one possible implementation, the first indication information is used to indicate whether the terminal device sends the first location information. The terminal device determines whether to send the first location information to the network device based on the indication of the first indication information.

As another possible implementation, the first indication information is used to indicate the configuration for sending the first location information, and the terminal device can send the first location information to the network device according to the indication of the first indication information sent by the network device and according to the configuration indicated by the first indication information.

As yet another possible implementation, the first indication information is used to indicate whether the terminal device sends the first location information and the configuration for sending the first location information.

Step 702: sending third configuration information to the terminal device, where the third configuration information is used to measure at least one candidate satellite for assisting positioning to obtain a third measurement result.

In the embodiments of the present disclosure, the network device sends third configuration information to the terminal device, where the third configuration information is used to measure at least one candidate satellite for assisting positioning to obtain a third measurement result. The terminal device measures the at least one candidate satellite for assisting positioning according to the third configuration information.

It can be understood that the at least one candidate satellite for assisting positioning refers to one or more satellites observable by the terminal device that can assist in positioning.

Optionally, in the embodiments of the present disclosure, the third configuration information includes at least one of:
an identifier of the at least one candidate satellite for assisting positioning;
a time-frequency domain location for measuring the at least one candidate satellite for assisting positioning; or
pilot information of the at least one candidate satellite for assisting positioning.

For example, the terminal device may detect the pilot of the candidate satellite at the configured time-frequency domain location according to the third configuration information to determine the measurement result of the candidate satellite.

It can be understood that the third configuration information can be flexibly configured and adjusted based on actual requirements.

Step 703: receiving the third measurement result sent by the terminal device.

In the embodiments of the present disclosure, the network device receives the third measurement result sent by the terminal device and determines the second positioning measurement configuration based on the third measurement result. The third measurement result is obtained by the terminal device measuring the at least one candidate satellite for assisting positioning according to the third configuration information sent by the network device.

Optionally, the third measurement result includes at least one of: ephemeris information of the at least one candidate satellite for assisting positioning, or received signal strength information corresponding to each candidate satellite.

The received signal strength information may be the average strength of received signals over a period of time or other strength indicators.

It can be understood that the third measurement result can also include other information that the terminal device can measure according to actual needs, so that the network device can determine the second measurement configuration information based on the third measurement result.

Further, in some embodiments, the network device may also send fourth configuration information to the terminal device, where the fourth configuration information is used to determine the time-frequency domain location for sending the third measurement result. The terminal device can send, according to the fourth configuration information, the third measurement result at the time-frequency domain location configured by the fourth configuration information.

Optionally, the third measurement result includes at least one of: ephemeris information of the at least one candidate satellite for assisting positioning, or received signal strength information corresponding to each candidate satellite of the at least one candidate satellite for assisting positioning.

It can be understood that the third measurement result can also include other information that the terminal device can measure according to actual needs, so that the network device can determine the second measurement configuration information based on the third measurement result

Step 704: determining the second positioning measurement configuration based on the third measurement result.

In the embodiments of the present disclosure, the network device determines the second positioning measurement configuration to be sent to the terminal device based on the third measurement result. The second positioning measurement configuration is used by the terminal device to perform the second positioning measurement and obtain the second positioning measurement result, the second positioning measurement result is used to determine the second location information of the terminal device.

Optionally, in the embodiments of the present disclosure, the second positioning measurement may be a multi-satellite-assisted positioning measurement.

The second positioning measurement configuration includes at least one of:
an identifier of a satellite assisting positioning;
pilot information for performing the second positioning measurement;
a time-frequency domain location for performing the second positioning measurement;
periodic information for performing the second positioning measurement.

It can be understood that the satellite assisting positioning refers to at least one satellite participating in the second positioning measurement. The terminal device can perform the second positioning measurement through the at least one satellite to complete network positioning.

Step 705: sending the second positioning measurement configuration to the terminal device.

In the embodiments of the present disclosure, the network device sends the second positioning measurement configuration to the terminal device, which is used by the terminal device to perform the second positioning measurement and obtain the second positioning measurement result. The second positioning measurement result is used to determine the second location information of the terminal device.

Optionally, in the embodiments of the present disclosure, the second positioning measurement may be a multi-satellite-assisted positioning measurement.

Step 706: receiving the first information sent by the terminal device.

In the embodiments of the present disclosure, the network device can receive the first information sent by the terminal device, the first information is used to verify whether the first location information obtained based on the first positioning measurement and reported to the network device by the terminal device is reliable.

Optionally, the first information may be the second positioning measurement result obtained by performing the second positioning measurement or the second location information determined based on the second measurement result.

The second measurement result is obtained through performing, by the terminal device, the second positioning measurement according to the received second positioning measurement configuration. The second positioning measurement result is used to determine the second location information of the terminal device.

Optionally, the second positioning measurement result may include a time difference of arrival (TDOA) and/or multiple round-trip times (Multi-RTT), etc.

It can be understood that the second positioning measurement result may also include other information required for positioning based on actual needs, to facilitate the determination of the second location information of the terminal device.

Optionally, in this embodiment, the terminal device may determine its own second location information based on the second positioning measurement result, or the network device may determine the second location information of the terminal device based on the second measurement result.

Step 707: verifying the reliability of the first location information based on the first information.

In the embodiments of the present disclosure, the network device verifies the reliability of the first location information reported by the terminal device based on the first information sent by the terminal device.

As described above, the first information may be the second positioning measurement result obtained by performing the second positioning measurement or the second location information determined based on the second measurement result.

In some embodiments, the network device receives the second measurement result sent by the terminal device and verifies whether the first location information is reliable based on the second measurement result.

In some embodiments, the network device receives the second location information determined by the terminal device based on the second measurement result and verifies the reliability of the first location information based on the second location information.

In summary, by receiving the first location information of the terminal device sent by the terminal device, where the first location information is obtained based on the first positioning measurement), sending third configuration information to the terminal device, where the third configuration information is used to measure at least one candidate satellite for assisting positioning to obtain a third measurement result, receiving the third measurement result sent by the terminal device, determining the second positioning measurement configuration based on the third measurement result, receiving the first information sent by the terminal device, and verifying the reliability of the first location information based on the first information, the terminal device can complete network positioning through multiple satellites, thereby enabling the network device to effectively determine the reliability of the location information reported by the terminal, avoiding the effect on transmissions of other terminals in an NTN system when the reported location is unreliable.

Corresponding to the positioning verification methods provided in the above embodiments, the present disclosure further provides a positioning verification apparatus. Since the positioning verification apparatus corresponds to the methods described in the above embodiments, the implementations of the positioning verification methods also apply to the apparatus described below. Detailed descriptions are omitted in the following embodiments.

Please refer to FIG. 8, which is a schematic structural diagram of a positioning verification apparatus according to an embodiment of the present disclosure.

As shown in FIG. 8, the positioning verification apparatus 800 includes a transceiver unit 810 and a processing unit 820.

The transceiver unit 810 is configured to send first location information of a terminal device to a network device, wherein the first location information is obtained based on a first positioning measurement.

The transceiver unit 810 is further configured to receive a second positioning measurement configuration sent by the network device.

The processing unit 820 is configured to perform a second positioning measurement according to the second positioning measurement configuration to obtain a second positioning measurement result, wherein the second positioning measurement result is used to determine second location information of the terminal device.

The transceiver unit 810 is further configured to send first information to the network device, wherein the first information is used to verify a reliability of the first location information.

Optionally, the first information is the second positioning measurement result or the second location information.

Optionally, the transceiver unit 810 is further configured to receive first configuration information sent by the network device, where the first configuration information is used for the terminal device to send the first location information and includes periodic information for sending the first location information.

Optionally, the transceiver unit 810 is further configured to receive first indication information sent by the network device, where the first indication information is used to indicate whether the terminal device sends the first location information and/or to indicate a configuration for sending the first location information.

Optionally, the second positioning measurement configuration includes at least one of:
an identifier of a satellite assisting positioning;
pilot information for performing the second positioning measurement;
a time-frequency domain location for performing the second positioning measurement;
periodic information for performing the second positioning measurement.

Optionally, the second positioning measurement configuration is determined by the network device based on ephemeris information of at least one candidate satellite for assisting positioning.

Optionally, the transceiver unit 810 is further configured to receive third configuration information sent by the network device, where the third configuration information is used to measure at least one candidate satellite for assisting positioning. The processing unit 820 is further configured to measure the at least one candidate satellite for assisting positioning according to the third configuration information to obtain a third measurement result, where the third measurement result is used for the network device to determine the second positioning measurement configuration. The transceiver unit 810 is further configured to send the third measurement result to the network device.

Optionally, the transceiver unit 810 is further configured to receive fourth configuration information sent by the network device, where the fourth configuration information is used to determine a time-frequency domain location for sending the third measurement result.

Optionally, the third configuration information includes at least one of:
identifiers of the at least one candidate satellite for assisting positioning;
time-frequency domain locations for measuring the at least one candidate satellite for assisting positioning;
pilot information of the at least one candidate satellite for assisting positioning.

Optionally, the third measurement result includes: ephemeris information of the at least one candidate satellite for assisting positioning, and/or received signal strength information corresponding to the at least one candidate satellite for assisting positioning.

The positioning verification apparatus of this embodiment enables the terminal device to complete network positioning through multiple satellites by sending the first location information of the terminal device to the network device, where the first location information is obtained based on the first positioning measurement, receiving the second positioning measurement configuration sent by the network device, performing the second positioning measurement according to the second positioning measurement configuration to obtain the second positioning measurement result, where the second positioning measurement result is used to determine the second location information of the terminal device, and sending the first information to the network device, where the first information is used to verify a reliability of the first location information, thereby enabling the network device to effectively determine whether the location information reported by the terminal is reliable, avoiding the effect on transmissions of other terminals in the NTN system when the location information reported by the terminal is unreliable.

Please refer to FIG. 9, which is a schematic structural diagram of a positioning verification apparatus according to an embodiment of the present disclosure.

As shown in FIG. 9, the positioning verification apparatus 900 includes a transceiver unit 910 and a processing unit 920.

The transceiver unit 910 is configured to receive first location information of a terminal device sent by the terminal device, where the first location information is obtained based on a first positioning measurement.

The transceiver unit 910 is further configured to send a second positioning measurement configuration to the terminal device, where the second positioning measurement configuration is used for the terminal device to perform a second positioning measurement to obtain a second positioning measurement result, and the second positioning measurement result is used to determine second location information of the terminal device.

The transceiver unit 910 is further configured to receive first information sent by the terminal device.

The processing unit 920 is configured to verify the reliability of the first location information based on the first information.

Optionally, the first information is the second positioning measurement result or the second location information.

Optionally, the transceiver unit 910 is further configured to send first configuration information to the terminal device, where the first configuration information is used for the terminal device to send the first location information and includes periodic information for sending the first location information.

Optionally, the transceiver unit 910 is further configured to send first indication information to the terminal device, where the first indication information is used to indicate whether the terminal device sends the first location information and/or to indicate a configuration for sending the first location information.

Optionally, the second positioning measurement configuration includes at least one of:
an identifier of a satellite assisting positioning;
pilot information for performing the second positioning measurement;
a time-frequency domain location for performing the second positioning measurement;
periodic information for performing the second positioning measurement.

Optionally, the transceiver unit 910 is further configured to obtain ephemeris information of at least one candidate satellite for assisting positioning and determine the second positioning measurement configuration based on the ephemeris information.

Optionally, the transceiver unit 910 is further configured to send third configuration information to the terminal device, where the third configuration information is used to measure at least one candidate satellite for assisting positioning to obtain a third measurement result used for the network device to determine the second positioning measurement configuration, receive the third measurement result sent by the terminal device, and determine the second positioning measurement configuration based on the third measurement result.

Optionally, the transceiver unit 910 is further configured to send fourth configuration information to the terminal device, where the fourth configuration information is used to determine a time-frequency domain location for sending the third measurement result.

Optionally, the third configuration information includes at least one of:
an identifier of the at least one candidate satellite for assisting positioning;
a time-frequency domain location for measuring the at least one candidate satellite for assisting positioning; or
pilot information of the at least one candidate satellite for assisting positioning.

Optionally, the third measurement result includes: ephemeris information of the at least one candidate satellite for assisting positioning, and/or received signal strength information corresponding to the at least one candidate satellite for assisting positioning.

The positioning verification apparatus of this embodiment enables the terminal device to complete network positioning through multiple satellites, by receiving the first location information of the terminal device sent by the terminal device, where the first location information is obtained based on the first positioning measurement, sending the second positioning measurement configuration to the terminal device, where the second positioning measurement configuration is used for the terminal device to perform the second positioning measurement to obtain the second positioning measurement result, and the second positioning measurement result is used to determine the second location information of the terminal device, receiving the first information sent by the terminal device, and verifying the reliability of the first location information based on the first information, thereby enabling the network device to effectively determine whether the location information reported by the terminal is reliable, and avoiding the effect on the transmission of other terminals in the NTN system when the location reported by the terminal is unreliable.

To achieve the above embodiments, the embodiments of the present disclosure further propose a communication device, comprising: a processor and a memory, wherein the memory stores a computer program, and the processor executes the computer program stored in the memory to enable the device to execute the methods shown in Embodiments 2 to 4.

To achieve the above embodiments, the embodiments of the present disclosure further propose a communication device, comprising: a processor and a memory, wherein the memory stores a computer program, and the processor executes the computer program stored in the memory to enable the device to execute the methods shown in embodiments of FIG. 5 to FIG. 7.

To achieve the above embodiments, the embodiments of the present disclosure further propose a communication device, comprising: a processor and an interface circuit, where the interface circuit is configured to receive code instructions and transmit them to the processor, and the processor is configured to execute the code instructions to perform the methods shown in embodiments of FIG. 2 to FIG. 4.

To achieve the above embodiments, the embodiments of the present disclosure further propose a communication device, comprising: a processor and an interface circuit, where the interface circuit is configured to receive code instructions and transmit them to the processor, and the processor is configured to execute the code instructions to perform the methods shown in embodiments of FIG. 5 to FIG. 7.

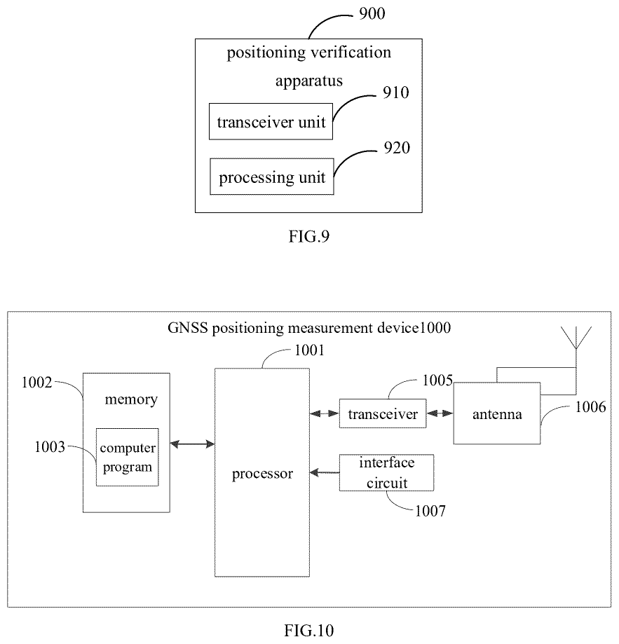

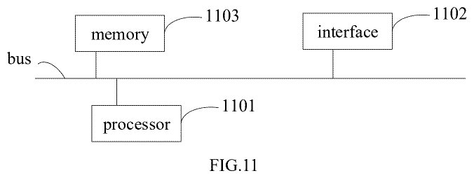

Please refer to FIG. 10, which is a schematic structural diagram of another positioning verification device according to an embodiment of the present disclosure. The positioning verification device 1000 may be a network device, a terminal device, a chip, a chip system, or a processor that supports the network device in implementing the above methods, or a chip, a chip system, or a processor that supports the terminal device in implementing the above methods. The device may be used to implement the methods described in the above method embodiments, and specific details can be found in the descriptions of the above method embodiments.

The positioning verification device 1000 may include one or more processors 1001. The processor 1001 may be a general-purpose processor or a special-purpose processor, such as a baseband processor or a central processing unit. The baseband processor may be used to process communication protocols and communication data, and the central processing unit may be used to control the positioning verification device (e.g., a base station, a baseband chip, a terminal device, a terminal device chip, a DU, or a CU, etc.), execute computer programs, and process data from the computer programs.

Optionally, the positioning verification device 1000 may further include one or more memories 1002, on which a computer program 1003 may be stored. The processor 1001 executes the computer program 1003 to enable the positioning verification device 1000 to perform the methods described in the above method embodiments. The computer program 1003 may be embedded in the processor 1001, in which case the processor 1001 may be implemented by hardware.

Optionally, the memory 1002 may also store data. The positioning verification device 1000 and the memory 1002 may be set separately or integrated together.

Optionally, the positioning verification device 1000 may further include a transceiver 1005 and an antenna 1006. The transceiver 1005 may be referred to as a transceiver unit, a transceiver machine, or a transceiver circuit, and is used to implement transceiver functions. The transceiver 1005 may include a receiver and a transmitter, where the receiver may be referred to as a receiver machine or a receiver circuit, and is used to implement receiving functions; the transmitter may be referred to as a transmitter machine or a transmitter circuit, and is used to implement transmitting functions.

Optionally, the positioning verification device 1000 may further include one or more interface circuits 1007. The interface circuit 1007 is used to receive code instructions and transmit them to the processor 1001. The processor 1001 executes the code instructions to enable the positioning verification device 1000 to perform the methods described in the above method embodiments.

In one implementation, the processor 1001 may include a transceiver for implementing receiving and transmitting functions. For example, the transceiver may be a transceiver circuit, an interface, or an interface circuit. The transceiver circuit, interface, or interface circuit for implementing receiving and transmitting functions may be separate or integrated together. The above-mentioned transceiver circuit, interface, or interface circuit may be used for reading/writing code/data, or for transmitting or transferring signals.

In one implementation, the positioning verification device 1000 may include a circuit, which may implement the functions of sending, receiving, or communicating as described in the foregoing method embodiments. The processor and transceiver described in the present disclosure may be implemented in an integrated circuit (IC), an analog IC, a radio frequency integrated circuit (RFIC), a mixed-signal IC, an application-specific integrated circuit (ASIC), a printed circuit board (PCB), an electronic device, etc. The processor and transceiver may also be manufactured using various IC process technologies, such as complementary metal-oxide-semiconductor (CMOS), N-type metal-oxide-semiconductor (NMOS), P-type metal-oxide-semiconductor (PMOS), bipolar junction transistor (BJT), bipolar CMOS (BiCMOS), silicon germanium (SiGe), gallium arsenide (GaAs), etc.

The positioning verification device described in the above embodiments may be a network device or a terminal device, but the scope of the positioning verification device described in the present disclosure is not limited to this, and the structure of the positioning verification device is not limited by FIGS. 8-9. The positioning verification device may be an independent device or part of a larger device. For example, the positioning verification device may be:
(1) An independent integrated circuit (IC), or a chip, or a chip system or subsystem;
(2) A collection of one or more ICs, optionally, the IC collection may also include storage components for storing data and computer programs;
(3) An ASIC, such as a modem;
(4) A module that can be embedded in other devices;
(5) A receiver, terminal device, smart terminal device, cellular phone, wireless device, handset, mobile unit, vehicle-mounted device, network device, cloud device, artificial intelligence device, etc. ;
(6) Others, etc.

For the case where the positioning verification device is a chip or chip system, please refer to the schematic structural diagram of the chip shown in FIG. 11. The chip shown in FIG. 11 includes a processor 1101 and an interface 1102. The number of processors 1101 may be one or more, and the number of interfaces 1102 may be multiple.

For the case where the chip is used to implement the functions of the terminal device in the embodiments of the present disclosure:

The interface 1102 is used to receive code instructions and transmit them to the processor;

The processor 1101 is used to execute the code instructions to perform the methods shown in FIGS. 2 to 4.

For the case where the chip is used to implement the functions of the network device in the embodiments of the present disclosure:

The interface 1102 is used to receive code instructions and transmit them to the processor;

The processor 1101 is used to execute the code instructions to perform the methods shown in FIGS. 5 to 7.

Optionally, the chip further includes a memory 1103, which is used to store necessary computer programs and data.

Those skilled in the art can also understand that the various illustrative logical blocks and steps listed in the embodiments of the present disclosure can be implemented by electronic hardware, computer software, or a combination of both. Whether such functions are implemented by hardware or software depends on the specific application and design constraints of the overall system. Those skilled in the art can use various methods to implement the described functions for each specific application, but such implementation should not be understood as beyond the scope of the embodiments of the present disclosure.

The embodiments of the present disclosure also provide a communication system, which includes the positioning verification device as a terminal device and the positioning verification device as a network device in the embodiments shown in FIGS. 8-9, or the system includes the positioning verification device as a terminal device and the positioning verification device as a network device in the embodiment shown in FIG. 10.

This application also provides a readable storage medium on which instructions are stored, and when the instructions are executed by a computer, the functions of any of the above method embodiments are implemented.

This application also provides a computer program product that, when executed by a computer, implements the functions of any of the above method embodiments.

In the above embodiments, the methods may be implemented entirely or partially by software, hardware, firmware, or any combination thereof. When implemented by software, the methods may be implemented entirely or partially in the form of a computer program product. The computer program product includes one or more computer programs. When the computer program is loaded and executed on a computer, the processes or functions according to the embodiments of the present disclosure are generated entirely or partially. The computer may be a general-purpose computer, a special-purpose computer, a computer network, or other programmable devices. The computer program may be stored in a computer-readable storage medium or transmitted from one computer-readable storage medium to another, for example, the computer program may be transmitted from a website, computer, server, or data center to another website, computer, server, or data center via wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or data center that integrates one or more available media. The available medium may be a magnetic medium (e.g., floppy disk, hard disk, magnetic tape), an optical medium (e.g., DVD), or a semiconductor medium (e.g., solid-state drive (SSD)), etc.

Those skilled in the art can understand that the various numerical references such as first, second, etc., in the present disclosure are only for the convenience of description and are not used to limit the scope of the embodiments of the present disclosure, nor do they indicate any order.

In the present disclosure, “at least one” may also be described as “one or more,” and “multiple” may be two, three, four, or more, and the present disclosure does not limit this. In the embodiments of the present disclosure, for a technical feature, the technical features in the technical feature are distinguished by “first,” “second,” “third,” “A,” “B,” “C,” and “D,” etc., and there is no sequence or order between the technical features described by “first,” “second,” “third,” “A,” “B,” “C,” and “D.”

The correspondence shown in the tables in the present disclosure may be configured or predefined. The values of the information in the tables are only examples and may be configured as other values, and the present disclosure does not limit this. When configuring the correspondence between the configuration information and the parameters, it is not necessary to configure all the correspondences shown in the tables. For example, in the tables in the present disclosure, some rows showing the correspondence may not be configured. For example, the above tables may be appropriately modified, such as split, merged, etc. The names of the parameters shown in the titles of the above tables may also be other names that can be understood by the communication device, and the values or representations of the parameters may also be other values or representations that can be understood by the communication device. The above tables may also be implemented using other data structures, such as arrays, queues, containers, stacks, linear tables, pointers, linked lists, trees, graphs, structures, classes, heaps, hash tables, etc.

In the present disclosure, “predefined” may be understood as defined, predefined, stored, pre-stored, pre-negotiated, pre-configured, solidified, or pre-burned.

Those skilled in the art can understand that the units and algorithm steps of the examples described in the embodiments disclosed in this document can be implemented by electronic hardware, or a combination of computer software and electronic hardware. Whether these functions are implemented by hardware or software depends on the specific application and design constraints of the technical solution. Professionals can use different methods to implement the described functions for each specific application, but such implementation should not be considered beyond the scope of the present disclosure.

Those skilled in the art can clearly understand that, for the convenience and brevity of description, the specific working processes of the systems, devices, and units described above can refer to the corresponding processes in the foregoing method embodiments, and will not be repeated here.

It should be understood that the various forms of processes shown above can be reordered, added, or deleted. For example, the steps described in the embodiments of the present disclosure can be executed in parallel, sequentially, or in different orders, as long as the desired results of the technical solutions disclosed in the present disclosure can be achieved, and this document does not limit this.

The above specific implementations do not constitute a limitation on the scope of protection of this invention. Those skilled in the art should understand that various modifications, combinations, sub-combinations, and substitutions can be made according to design requirements and other factors. Any modifications, equivalent replacements, and improvements made within the principles of this invention shall be included within the scope of protection of this invention.

1. A positioning verification method, performed by a terminal device, comprising:
sending first location information of the terminal device to a network device, wherein the first location information is obtained based on a first positioning measurement;
receiving a second positioning measurement configuration sent by the network device;
performing a second positioning measurement according to the second positioning measurement configuration to obtain a second positioning measurement result, wherein the second positioning measurement result is used to determine second location information of the terminal device; and
sending first information to the network device, wherein the first information is used to verify a reliability of the first location information.

2. The method according to claim 1, wherein the first information is one of the second positioning measurement result, or the second location information.

3. The method according to claim 1, further comprising:
receiving at least one of first configuration information or first indication information sent by the network device,
wherein the first configuration information is used for the terminal device to send the first location information, and the first configuration information comprises periodic information for sending the first location information;
wherein the first indication information is used to indicate whether the terminal device sends the first location information, and/or the first indication information is used to indicate a configuration for sending the first location information.

4. (canceled)

5. The method according to claim 2, wherein the second positioning measurement configuration comprises at least one of:
an identifier of a satellite assisting positioning;
pilot information for performing the second positioning measurement;
a time-frequency domain location for performing the second positioning measurement; or
periodic information for performing the second positioning measurement.

6. The method according to claim 5, wherein the second positioning measurement configuration is determined by the network device based on ephemeris information of at least one candidate satellite for assisting positioning.

7. The method according to claim 5, further comprising:
receiving third configuration information sent by the network device, wherein the third configuration information is used to measure at least one candidate satellite for assisting positioning;
measuring the at least one candidate satellite for assisting positioning, according to the third configuration information, to obtain a third measurement result, wherein the third measurement result is used for the network device to determine the second positioning measurement configuration; and
sending the third measurement result to the network device.

8. The method according to claim 7, further comprising:
receiving fourth configuration information sent by the network device, wherein the fourth configuration information is used to determine a time-frequency domain location for sending the third measurement result.

9. The method according to claim 7, wherein the third configuration information comprises at least one of:
an identifier of the at least one candidate satellite for assisting positioning;
a time-frequency domain location for measuring the at least one candidate satellite for assisting positioning; or
pilot information of the at least one candidate satellite for assisting positioning.

10. The method according to claim 9, wherein the third measurement result comprises: ephemeris information of the at least one candidate satellite for assisting positioning, and/or received signal strength information corresponding to the at least one candidate satellite for assisting positioning.

11. A positioning verification method, performed by a network device, comprising:
receiving first location information of a terminal device sent by the terminal device, wherein the first location information is obtained based on a first positioning measurement;
sending a second positioning measurement configuration to the terminal device, wherein the second positioning measurement configuration is used for the terminal device to perform a second positioning measurement to obtain a second positioning measurement result, and the second positioning measurement result is used to determine second location information of the terminal device;
receiving first information sent by the terminal device; and
verifying a reliability of the first location information based on the first information.

12. The method according to claim 11, wherein the first information is the second positioning measurement result, or the first information is the second location information.

13. The method according to claim 11, further comprising:
sending at least one of first configuration information or first indication information to the terminal device,
wherein the first configuration information is used for the terminal device to send the first location information, and the first configuration information comprises periodic information for sending the first location information;
wherein the first indication information is used to indicate whether the terminal device sends the first location information, and/or the first indication information is used to indicate a configuration for sending the first location information.

14. (canceled)

15. The method according to claim 12, wherein the second positioning measurement configuration comprises at least one of:
an identifier of a satellite assisting positioning;
pilot information for performing the second positioning measurement;
a time-frequency domain location for performing the second positioning measurement; or
periodic information for performing the second positioning measurement.

16. The method according to claim 15, further comprising:
obtaining ephemeris information of at least one candidate satellite for assisting positioning;
determining the second positioning measurement configuration based on the ephemeris information of the at least one candidate satellite for assisting positioning.

17. The method according to claim 15, further comprising:
sending third configuration information to the terminal device, wherein the third configuration information is used to measure at least one candidate satellite for assisting positioning to obtain a third measurement result, and the third measurement result is used for the network device to determine the second positioning measurement configuration;
receiving the third measurement result sent by the terminal device; and
determining the second positioning measurement configuration based on the third measurement result.

18. The method according to claim 17, further comprising:
sending fourth configuration information to the terminal device, wherein the fourth configuration information is used to determine a time-frequency domain location for sending the third measurement result.

19. The method according to claim 17, wherein the third configuration information comprises at least one of:
an identifier of the at least one candidate satellite for assisting positioning;
a time-frequency domain location for measuring the at least one candidate satellite for assisting positioning; or
pilot information of the at least one candidate satellite for assisting positioning.

20. The method according to claim 19, wherein the third measurement result comprises: ephemeris information of the at least one candidate satellite for assisting positioning, and/or received signal strength information corresponding to the at least one candidate satellite for assisting positioning.

21-22. (canceled)

23. A terminal device, comprising a processor and a memory, wherein the memory stores a computer program, and the processor is configured to:
send first location information of the terminal device to a network device, wherein the first location information is obtained based on a first positioning measurement;
receive a second positioning measurement configuration sent by the network device;
perform a second positioning measurement according to the second positioning measurement configuration to obtain a second positioning measurement result, wherein the second positioning measurement result is used to determine second location information of the terminal device; and
send first information to the network device, wherein the first information is used to verify a reliability of the first location information.

24-26. (canceled)

27. A network device, comprising a processor and a memory having stored a computer program thereon which, when executed by a processor, enables the network device to perform the method according claim 11.
